(19) United States
(12) Patent Application Publication
(10) Pub. No.: US 2009/0259396 A1
(43) Pub. Date: Oct. 15, 2009

(54) SAFE GUIDANCE METHOD AND GLOBAL NAVIGATION SATELLITE SYSTEM DEVICE THEREOF

(75) Inventor: Jin-song He, Hefei Anhui (CN)

Correspondence Address: KIRTON AND MCCONKIE, 60 EAST SOUTH TEMPLE,, SUITE 1800, SALT LAKE CITY, UT, 84111, US

(73) Assignee: MEDIATEK (Heifei) INC., Hefei City (CN)

(21) Appl. No.: 12/164,046

(22) Filed: Jun. 28, 2008

(30) Foreign Application Priority Data
Apr. 11, 2008 (CN) 200810035976.7

(51) Int. Cl. G01C 21/26; G01C 21/00

(52) U.S. Cl. 701/211; 701/213

(57) ABSTRACT

Disclosed is a safe guidance method and Global Navigation Satellite System device thereof. The safe guidance method comprises steps: obtaining at least one caution zone from a map database of the Global Navigation Satellite System device; and playing a notification when approaching the caution zone according to a notifying rule. The safe guidance method further comprises a step of defining the caution zone before the step of obtaining the caution zone and a step of playing a warning after entering the caution zone. Furthermore, the notifying rule defines a distance near the caution zone for playing the notification. A user of the Global Navigation Satellite System device can define the caution zone and predetermine the aforesaid distance before the user travels on the road. The notification and the warning can be voice hints or image hints.

### BACKGROUND OF THE INVENTION

1. Field of the Invention

The present invention generally relates to a safe guidance method, and more particularly to a safe guidance method and Global Navigation Satellite System device thereof.

2. Description of Prior Art

A Global Navigation Satellite System device has become a widely used application in commercial positioning locator products. For example, it is applied in various transportation vehicles on land, at sea, and in the air to allow users to exactly confirm their current positions by using the Global Navigation Satellite System devices.

Before the user travels on the road, a course may be programmed in advance. A general Global Navigation Satellite System device is concerning only about the path from the beginning to the destination, and the general Global Navigation Satellite System is focusing on guiding the user how to arrive at the destination anyway via the Global Navigation Satellite system. For higher requirement of traffic safety nowadays, a safe guidance and related notification or warning involving caution zones which can be anywhere around on the map and are deemed to be essentially required to the user of the Global Navigation Satellite System device.

Accordingly, providing a safe guidance method and Global Navigation Satellite System device thereof can satisfy the user's demands for safely guiding oneself before arriving the destination and higher traffic safety request.

### SUMMARY OF THE INVENTION

An objective of the present invention is to provide a safe guidance method and Global Navigation Satellite System device thereof to give the user of the Global Navigation Satellite System device a distance hint of approaching a caution zone and a caution zone hint.

The safe guidance method of the present invention comprises steps of:

obtaining at least one caution zone from a map database of the Global Navigation Satellite System device; and

playing a notification when approaching the caution zone according to a notifying rule.

The safe guidance method of the present invention further comprises a step of defining the caution zone in advance and a step of playing a warning after entering the caution zone. The notifying rule may define a predetermined distance near the caution zone for playing the notification. A user of the Global Navigation Satellite System device can define the caution zone and pre-set the aforesaid predetermined distance in advance.

The Global Navigation Satellite System device of the present invention comprises a positioning system, a navigation module and an interface unit. The positioning system obtains a current position of the Global Navigation Satellite System device. The navigation module obtains at least one caution zone from a map database of the Global Navigation Satellite System device. The interface unit plays a notification when the current position is near the caution zone according to a notifying rule and also can play a warning when the current position is in the caution zone. The interface unit further comprises an input unit and an output unit as a human interface device. The notifying rule can define a predetermined distance near the caution zone for playing the notification. The predetermined distance can be pre-set by the user through the input unit of the interface unit in advance.

Specifically, the map database for obtaining the caution zone can be updated from time to time by the manufacturer of the Global Navigation Satellite System device or by the map database provider by linking to the web. The caution zone also can be manually defined and inputted into the map database by the user through the input unit of the interface unit.

The aforesaid notification when approaching the caution zone can be a voice hint or an image hint. Moreover, the aforesaid warning also can be a voice hint or an image hint.

The present invention can provide a better way of safe guidance by playing the notification when approaching the caution zone and the warning for the user of the Global Navigation Satellite System device when the user travels on the road.

### BRIEF DESCRIPTION OF THE DRAWINGS

FIG. 1 depicts a block diagram of a Global Navigation Satellite System device according to the present invention;

FIG. 2 depicts a safe guidance start-up shown by an interface unit of the Global Navigation Satellite System device according to the present invention; and

FIG. 3 depicts a setting dialog of a predetermined distance near the caution zone for playing the notification;

FIG. 4 depicts a flow chart of safe guidance method according to the present invention.

### DETAILED DESCRIPTION OF THE INVENTION

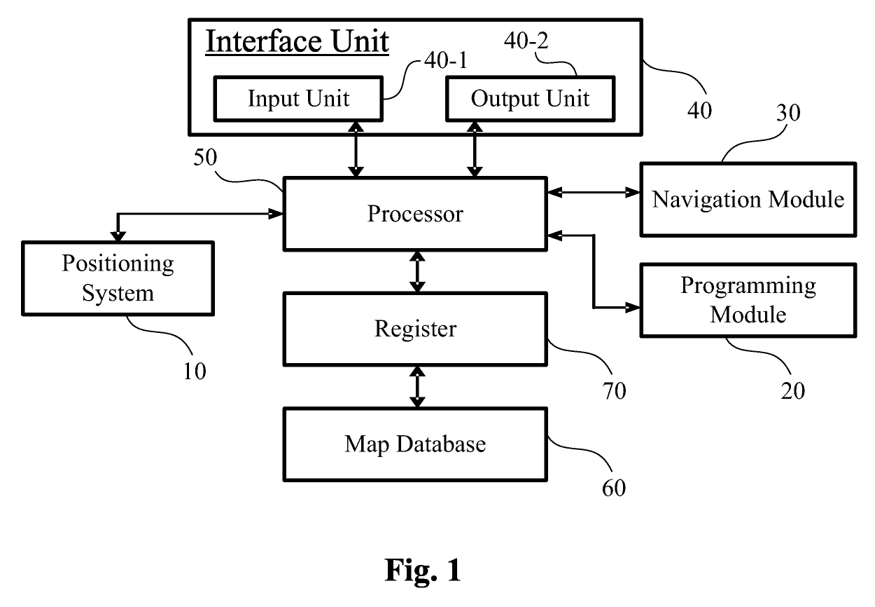

Please refer to FIG. 1, which depicts a block diagram of a Global Navigation Satellite System device according to the present invention. The Global Navigation Satellite System device according to the present invention comprises a positioning system 10, a programming module 20, a navigation module 30, an interface unit 40, a processor 50, a map database 60 and a register 70. The interface unit 40 further comprises an input unit 40-1 and an output unit 40-2.

The positioning system 10 recognizes and obtains a current position, a moving speed and a present direction of the Global Navigation Satellite System device. The mission of programming module 20 is to program a course for the user. The navigation module 30 generates and outputs navigation information to the interface unit 40 for the user according to the current position, the moving speed and the present direction of the Global Navigation Satellite System device. Therefore, the navigation module 30 of the present invention is employed to obtain at least one caution zone from a map database of the Global Navigation Satellite System device. The definition of the caution zone can be, for example, railroad grade crossing, school entrance, ferry port point, accident area, steep ramp, rugged road, slippery road, et cetera.

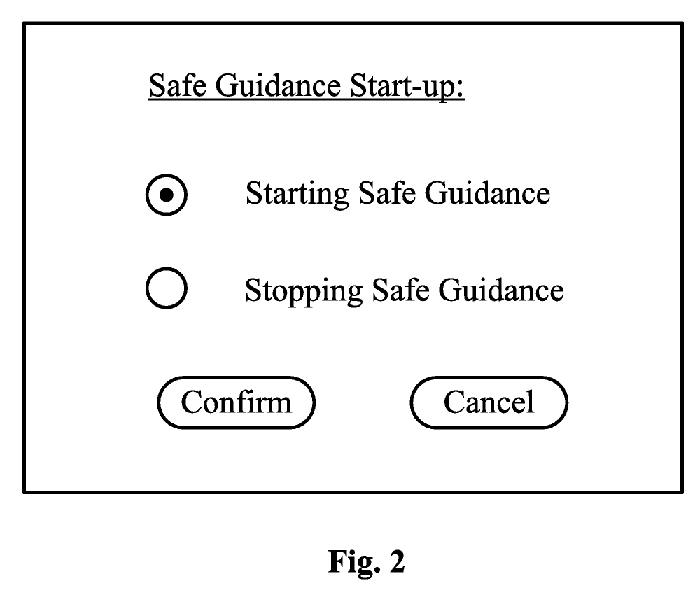

When the safe guidance is triggered as shown in FIG. 2 and after the user gets on the road, the navigation module 30 keeps confirming if the current position is near the caution zone than a predetermine distance and whether the user enters the caution zone or not. Once the distance near the caution zone is less than the predetermined distance, a notification when approaching the caution zone shows up on the output unit 40-2 to make the user notice that he is closing to the caution zone according to a notifying rule. The notification can be an image hint or a voice hint. And, once the user enters the caution zone, a warning on the output unit 40-2, such as, an image hint or a voice hint is triggered to make the user notice that he has already entered thereinto. The map database 60 stores map information and caution zones for the navigation module 30.

Please refer to FIG. 2, which depicts a safe guidance start-up shown by an interface unit of the Global Navigation Satellite System device according to the present invention. Before the user travels on the road with the Global Navigation Satellite System device, the safe guidance start-up can allow the user to choose to start the function of the notification and the warning or not.

The interface unit of the Global Navigation Satellite System device can further include a microphone and some control push buttons. Alternatively, the interface unit can also be a display or a touch panel as a portion of the input unit 40-1, which is shown in FIG. 1. The interface unit can be an aforesaid display or a panel to generate an image hint as the notification when approaching the caution zone or an image hint as the warning after entering the caution zone. Furthermore, the output unit 40-2 in FIG. 1 can further include a speaker to allow the notification or the warning generated as a voice hint. The safe guidance start-up in FIG. 2 shows on the aforesaid display or panel by the user's command when the user of the Global Navigation Satellite System device wants to start or stop the function of the notification and the warning.

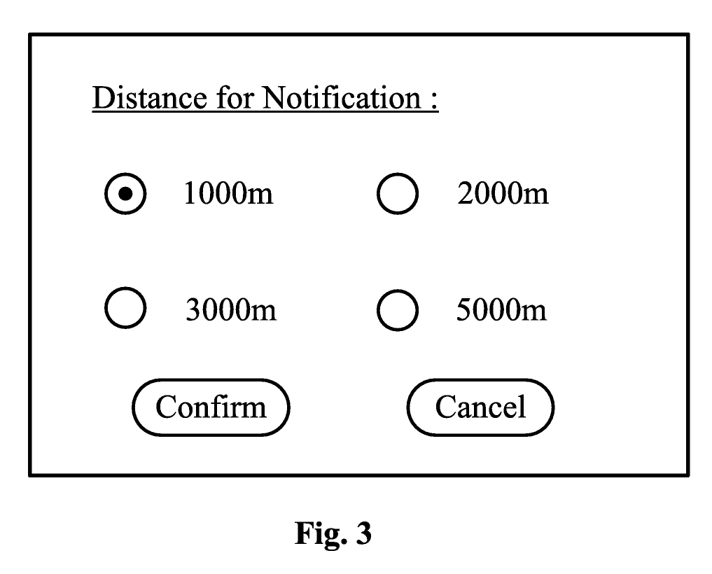

Please refer to FIG. 3, which depicts a setting dialog of a predetermined distance near the caution zone. In this case, the user selects the option of starting safe guidance showing in FIG. 2, and a setting dialog of a predetermined distance near the caution zone shown in FIG. 3 comes on the aforesaid display or panel after the user makes a confirm selection in FIG. 2. As shown in FIG. 3, the user of the Global Navigation Satellite System device may select distance options of 1000 m, 2000 m, 3000 m or 5000 m as an aforesaid predetermined distance for actuating the notification when approaching the caution zone. However, the aforesaid distance options are not restricted to the present invention. Either closer or further the distance options can be inputted when the Global Navigation Satellite System device is designed.

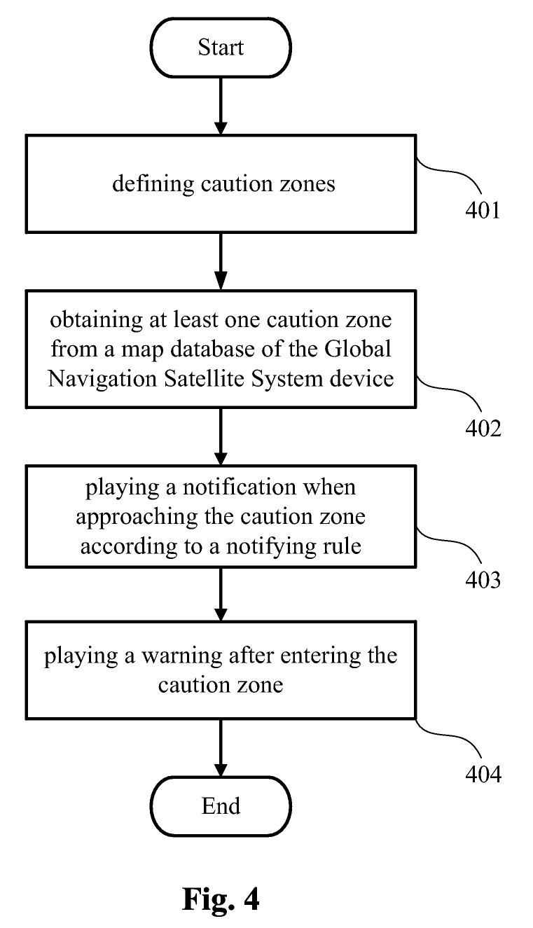

Please refer to FIG. 4, which depicts a flow chart of safe guidance method according to the present invention. The safe guidance method of the present invention includes steps below:

Step 401, defining caution zones;

Step 402, obtaining at least one caution zone from a map database of the Global Positioning System device;

Step 403, playing a notification when approaching the caution zone according to a notifying rule; and

Step 404, playing a warning after entering the caution zone. As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A safe guidance method for applying in a Global Navigation Satellite System device, the method comprising:
obtaining at least one caution zone from a map database of the Global Navigation Satellite System device; and
playing a notification when approaching the caution zone according to a notifying rule.

2. The safe guidance method of claim 1, further comprising a step of defining the caution zone before the step of obtaining the caution zone from the map database.

3. The safe guidance method of claim 2, wherein the caution zone is defined as a railroad grade crossing, a school entrance, a ferry port point, an accident area, a steep ramp, a rugged road, or a slippery road.

4. The safe guidance method of claim 1, wherein the notifying rule defines a distance near the caution zone for playing the notification.

5. The safe guidance method of claim 1, wherein the notification is a voice hint.

6. The safe guidance method of claim 1, wherein the notification is an image hint.

7. The safe guidance method of claim 1, further comprising a step of playing a warning after entering the caution zone.

8. The safe guidance method of claim 7, wherein the warning is a voice hint.

9. The safe guidance method of claim 7, wherein the warning is an image hint.

10. A Global Navigation Satellite System device to provide a user a safe guidance, comprising:
a positioning system, obtaining a current position of the Global Navigation Satellite System device;
a navigation module, obtaining at least one caution zone from a map database of the Global Navigation Satellite System device; and
an interface unit, playing a notification when the current position is near the caution zone according to a notifying rule and playing a warning when the current position is in the caution zone.

11. The Global Navigation Satellite System device of claim 10, wherein the caution zone is defined as a railroad grade crossing, a school entrance, a ferry port point, an accident area, a steep ramp, a rugged road, or a slippery road.

12. The Global Navigation Satellite System device of claim 10, wherein the interface unit further comprises an input unit and an output unit as a human interface device.

13. The Global Navigation Satellite System device of claim 12, wherein the notifying rule defines a distance near the caution zone for playing the notification through the input unit of the interface unit.

14. The Global Navigation Satellite System device of claim 10, wherein the notification is a voice hint.

15. The Global Navigation Satellite System device of claim 10, wherein the notification is an image hint.

16. The Global Navigation Satellite System device of claim 10, wherein the warning is a voice hint.

17. The Global Navigation Satellite System device of claim 10, wherein the warning is an image hint.
